(19) United States
(12) Patent Application Publication
(10) Pub. No.: US 2004/0150786 A1
(43) Pub. Date: Aug. 5, 2004

(54) Ear's comfort strip

(76) Inventor: Carol Ann Edwards, Detroit, MI (US)

Correspondence Address: Carol Ann Edwards, 12908 Payton, Detroit, MI, 48224, US

(21) Appl. No.: 10/261,127

(22) Filed: Jan. 21, 2003

(51) Int. Cl. G02C 5/14

(52) U.S. Cl. 351/123

(57) ABSTRACT

A new set of foam strips, designed to fit within the bridge of one's ear, to rest underneath the weight of the glasses handle, to relieve the ear of soreness. Each strip is coated with adhesive underneath to prevent movement of the foam, And to continue desired comfort.

As a child, I needed glasses. In my early 20's, I wore contacts with glasses as a Backup. Now early 40's, it's almost all glasses again.

Since 1976, I've been folding 2 squares of toilet tissue and placing it underneath my glasses handle, to keep my ear from being sore. Then, I thought, I wish somebody would make a comfort devise to sooth one's ear. That's when I realized the job was mine. My two witnesses are in need of the Product also. On behalf of gasses wearers all over the world, I find a need for the Comfort Ear Strip. The first model was built and tested on Apr. 28, 2002.

I claim:

1. A new set of foam strips designed to fit within the bridge of one's ear, to rest Underneath the weight of the glasses handle to relieve the ear of soreness. Each foam stripe is coated with adhesive to prevent movement of the foam to secure desired comfort.
